(19) United States
(12) Patent Application Publication
(10) Pub. No.: US 2025/0269356 A1
(43) Pub. Date: Aug. 28, 2025

(54) AMORPHOUS CATALYSTS FOR HYDROCRACKING OF FISCHER-TROPSCH WAX

(71) Applicant: Exxonmobil Technology and Engineering Company, Spring, TX (US)

(72) Inventors: Matthew T. Kapelewski, Lambertville, NJ (US); Raymond G. Burns, III, Louisville, KY (US); Lei Zhang, Basking Ridge, NJ (US)

(21) Appl. No.: 19/207,307

(22) Filed: May 13, 2025

Related U.S. Application Data
(63) Continuation of application No. PCT/US2023/079488, filed on Nov. 13, 2023.
(60) Provisional application No. 63/503,587, filed on May 22, 2023.

(51) Int. Cl. B01J 21/12; B01J 23/42; B01J 23/44; B01J 35/61; B01J 35/63; B01J 37/02; B01J 37/08; C10G 47/18

(52) U.S. Cl. CPC B01J 21/12; B01J 23/42; B01J 23/44; B01J 35/615; B01J 35/635; B01J 37/0201; B01J 37/0236; B01J 37/08; C10G 47/18

(57) ABSTRACT

Catalysts and corresponding methods are provided for conversion of Fischer-Tropsch wax to distillate boiling range products. The catalyst for performing the conversion can correspond to a noble metal catalyst supported on an amorphous silica-alumina support. The amorphous silica-alumina support can have a beneficial combination of surface area, pore volume, and acidity that provides for unexpectedly beneficial activity for conversion of Fischer-Tropsch wax. This can allow a target level of conversion during hydrocracking to be achieved at a reduced or minimized temperature and/or reaction severity. The unexpected properties for the amorphous silica-alumina support can be achieved in part by forming the support using an extrusion process where the extrusion mixture includes silica-alumina, nitric acid as a peptizing agent, and methylcellulose as an extrusion aid. The methylcellulose is then removed from the support via calcination, which contributes in part to the properties of the resulting support.

### CROSS-REFERENCE TO RELATED APPLICATIONS AND PRIORITY CLAIM

This application is a Continuation of PCT/US2023/079488, filed Nov. 13, 2023, and titled “Amorphous Catalysts For Hydrocracking Of Fischer-Tropsch Wax”, which claims the benefit of priority to U.S. Provisional Patent Application No. 63/503,587 filed May 22, 2023, and titled “Amorphous Catalysts For Hydrocracking Of Fischer-Tropsch Wax”, both of which are incorporated herein by reference in their entirety.

### FIELD OF THE INVENTION

Amorphous catalysts are provided, along with corresponding systems and methods, for using hydrocracking to improve the yield of liquid products from Fischer-Tropsch synthesis.

### BACKGROUND OF THE INVENTION

One pathway for production of liquid fuels from bio-derived sources is to convert biomass into a synthesis gas and then use Fischer-Tropsch (FT) synthesis to form fuel boiling range products. This type of pathway is advantageous because it avoids the need to directly form molecules of a target type and/or in a target boiling range. Instead, any convenient type of biomass can be broken down to form synthesis gas, and then FT synthesis is used to generate hydrocarbons.

Although Fischer-Tropsch synthesis conditions can be tuned to modify the average chain length, the output from FT synthesis typically corresponds to a product with a distribution of chain lengths according to the Anderson-Schulz-Flory distribution. Due to the nature of the distribution of chain lengths, using FT synthesis to form fuels boiling range also results in formation of a substantial amount of Fischer-Tropsch wax. Even under optimal conditions for producing distillate boiling range products, a Fischer-Tropsch synthesis process can typically produce 20 wt % or more of C₂₂₊ compounds that include a high proportion of paraffins. Such a C₂₂₊ fraction is an example of an FT wax. FT wax produced from syngas conversion is typically a highly paraffinic and high melting wax that is free of sulfur and nitrogen impurities. To increase the yield of fuels boiling range compounds (such as distillate boiling range compounds, jet boiling range compounds or naphtha boiling range compounds), the wax produced in this process must be further processed. Typical processing includes hydrocracking to form lighter molecules, with a range targeted based on the hydrocracking catalyst being used. It would be desirable to have improved catalysts, systems, and/or methods for converting such FT wax into fuels boiling range compounds.

U.S. Pat. No. 7,704,378 describes a catalyst for hydrocracking of a heavy Fischer-Tropsch fraction. The catalyst includes a silica-alumina support where the distribution of silica and alumina in the support is not uniform. Instead, there are distinct regions within the support having different ratios of silica to alumina.

U.S. Pat. No. 8,679,323 describes hydrocracking of a heavy Fischer-Tropsch fraction. The catalyst includes base-modified dealuminated USY with a Si/Al ratio prior to base modification and prior to mixing with a binder or support of 2.5 to 20.

U.S. Pat. No. 8,142,644 describes hydrocracking and hydroisomerization of a Fischer-Tropsch fraction where 50 wt % or more of the fraction boils at 370° C. or higher. The catalyst includes a carrier with a pore volume of 0.8 ml/g or more and a median pore diameter of 85 Angstroms or more. Additionally, the pores have a high degree of cylindrical character.

U.S. Pat. No. 8,685,231 describes hydrocracking and hydroisomerization of a Fischer-Tropsch fraction where 50 wt % or more of the fraction boils at 370° C. or higher. The catalyst includes 15 wt % or less of zeolite Beta and 40 wt % or more of a silica-alumina binder or carrier.

U.S. Pat. No. 6,583,186 describes a method for processing Fischer-Tropsch feed. The Fischer-Tropsch feed is separated into a lighter fraction and a heavier fraction. The heavier fraction is then hydrocracked and optionally isomerized. The lighter fraction is then mixed with the resulting hydrocracked effluent.

U.S. Pat. No. 10,227,537 describes processing of Fischer-Tropsch wax in a multi-step process that includes hydrocracking in the presence of a hydrocracking catalyst containing a zeolite and amorphous silicon-alumina.

U.S. Patent Application Publication 2011/0049011 describes hydrocracking of Fischer-Tropsch wax fractions. The hydrocracking catalysts correspond to mixtures of zeolites with silica-alumina, alumina-boria, or silica-zirconia.

U.S. Patent Application Publication 2004/0256287 describes hydrocracking of waxy feeds using a catalyst containing an acidic matrix such as amorphous silica alumina. Optionally, the catalyst can further include up to 2 wt % of a zeolite, such as USY.

U.S. Pat. No. 6,399,530 describes an amorphous silica-alumina carrier that can optionally be combined with crystalline materials for use as a hydrocracking catalyst. The amorphous silica-alumina is described as having a pore volume of 0.8 ml/g or more, with an SiO₂ content of 50 wt % or less.

### SUMMARY

In various aspects, a method for hydrocracking a waxy feedstock is provided. The method includes a feedstock containing 70 wt % or more of paraffins and having a T10 distillation point of 280° C. or higher to a catalyst under hydrocracking conditions including 20 wt % or more conversion relative to 371° C. to form a hydrocracking effluent. The catalyst can have 0.1 wt % to 3.0 wt % of a Group 8-10 noble metal on an extruded silica-alumina support. The extruded silica-alumina support can have a surface area of 360 m²/g or more and/or a pore volume of 0.55 cm³/g to 0.90 cm³/g.

In some aspects, the extruded silica-alumina support can be extruded from an extrusion mixture containing nitric acid as a peptizing agent and methylcellulose as an extrusion aid. Optionally, a weight ratio of silica-alumina to methylcellulose in the extrusion mixture is between 50 and 250. Optionally, a weight ratio of methylcellulose to nitric acid in the extrusion mixture is 0.2 to 0.8.

### BRIEF DESCRIPTION OF THE DRAWINGS

FIG. 1 shows distillate yield versus feed conversion relative to 371° C. for hydrocracking of a waxy feed in the presence of various hydrocracking catalysts.

FIG. 2 shows the reaction temperature for achieving 50 wt % conversion relative to 371° C. for hydrocracking of the waxy feed in the presence of various hydrocracking catalysts.

FIG. 3 shows conversion versus reaction temperature for hydrocracking of the waxy feed in the presence of hydrocracking catalyst as described herein.

FIG. 4A shows distillate yield and naphtha yield versus temperature during hydrocracking of the waxy feed in the presence of various hydrocracking catalysts.

FIG. 4B shows distillate yield and gas phase product yield versus temperature during hydrocracking of the waxy feed in the presence of various hydrocracking catalysts.

### DETAILED DESCRIPTION

### Overview

In various aspects, catalysts and corresponding methods are provided for conversion of Fischer-Tropsch wax to distillate boiling range products. The catalyst for performing the conversion can correspond to a noble metal catalyst supported on an amorphous silica-alumina support. The amorphous silica-alumina support can have a beneficial combination of surface area, pore volume, and acidity that provides for unexpectedly beneficial activity for conversion of Fischer-Tropsch wax. This can allow a target level of conversion during hydrocracking to be achieved at a reduced or minimized temperature and/or reaction severity. The unexpected properties for the amorphous silica-alumina support can be achieved in part by forming the support using an extrusion process where the extrusion mixture includes silica-alumina, nitric acid as a peptizing agent, and methylcellulose as an extrusion aid. The methylcellulose is then removed from the support via calcination, which contributes in part to the properties of the resulting support.

Conventionally, methods for improving the yield of distillate fuels from Fischer-Tropsch synthesis have focused on using catalysts corresponding to Group 8-10 metals supported on acidic support materials to crack the higher boiling range/waxy portion of the Fischer-Tropsch synthesis product. Conventionally, this acidity is believed to improve the cracking capabilities of the catalytic material. This acidic functionality in the support typically includes at least an acidic matrix material or binder. Examples of such acidic, amorphous matrix materials or binders include silica-alumina and fluorinated alumina. Acidity is often also provided based on the use of a zeotype framework in the support material.

In contrast to conventional methods, it has been discovered that high yields of distillate boiling range products can be achieved by cracking Fischer-Tropsch wax using catalysts based on using Group 8-10 noble metals (e.g., Pt, Pd) on amorphous silica-alumina supports having a beneficial combination of pore volume, surface area, and acidity. The resulting noble metal catalyst on the silica-alumina support can have sufficient cracking activity to achieve high yields of distillate compounds during cracking of Fischer-Tropsch wax while operating at low enough temperatures to reduce or minimize over-cracking to naphtha over the course of a commercial scale processing run.

### Definitions

In this discussion, a zeotype is defined to refer to a crystalline material having a porous framework structure built from tetrahedra atoms connected by bridging oxygen atoms. Examples of known zeotype frameworks are given in the “Atlas of Zeolite Frameworks” published on behalf of the Structure Commission of the International Zeolite Association”, 6^{th} revised edition, Ch. Baerlocher, L. B. McCusker, D. H. Olson, eds., Elsevier, New York (2007) and the corresponding web site, http://www.iza-structure.org/databases/. Under this definition, a zeolite refers specifically to an aluminosilicate having a zeotype framework structure. Under this definition, a zeotype can refer to aluminosilicates (i.e., zeolites) having a zeotype framework structure as well as crystalline structures containing oxides of heteroatoms different from silicon and aluminum. Such heteroatoms can include any heteroatom generally known to be suitable for inclusion in a zeotype framework, such as gallium, boron, germanium, phosphorus, zinc, and/or other transition metals that can substitute for silicon and/or aluminum in a zeotype framework. It is noted that under this definition, a zeotype can include materials such as silicoaluminophosphate (SAPO) materials or aluminophosphate (AlPO) materials.

In this discussion, conversion of a feedstock relative to 700° F. (371° C.) is defined based on the net weight percentage of the feedstock that boils at or above 371° C. prior to a process that is converted to compounds that boil below 371° C. after the conversion process. Unless otherwise specified, conversion values described herein correspond to single-pass conversion values.

In this discussion, “Tx” refers to the temperature at which a weight fraction “x” of a sample can be boiled or distilled. For example, if 40 wt % of a sample has a boiling point of 350° F. (177° C.) or less, the sample can be described as having a T40 distillation point of 350° F. (177° C.).

In this discussion, the distillate boiling range is defined as 160° C. (320° F.) to 371° C. A fraction that has a T10 distillation point of 160° C. or more and a T90 distillation point of 371° C. or less is defined as a distillate boiling range fraction. The naphtha boiling range is defined as the boiling point of a C₅ paraffin (roughly 29° C.) to 160° C. A fraction having a T10 boiling point of 29° C. or more and a T90 distillation point of 160° C. or less is defined as a naphtha boiling range fraction. It is noted that the T10 distillation point of a fraction must be equal to or less than the T90 distillation point, and that similarly the T90 distillation point of a fraction must be equal to or greater than the T10 distillation point. The distillation profile of a fraction, feed, or product is determined according to ASTM D2887. For a sample where ASTM D2887 is not appropriate for some reason, D86 (for lower boiling fractions) or D7169 (higher boiling fractions) may be used instead.

The “cloud point” of a sample is the temperature below which paraffin wax or other solid substances begin to crystallize or separate from the solution, imparting a cloudy appearance to the oil when the oil is chilled under prescribed conditions. Cloud point can be determined according to ASTM D2500

Unless otherwise specified, the “Liquid Hourly Space Velocity (LHSV)” for a feed or portion of a feed to a reactor is defined as the volume of feed per hour relative to the volume of catalyst in the reactor. In some specific instances, a liquid hourly space velocity may be specified relative to a specific catalyst within a reactor that contains multiple catalyst beds.

In this discussion, a “Cx” hydrocarbon refers to a hydrocarbon compound that includes “x” number of carbons in the compound. A stream containing “Cx-Cy” hydrocarbons refers to a stream composed of one or more hydrocarbon compounds that includes at least “x” carbons and no more than “y” carbons in the compound. It is noted that a stream containing “Cx-Cy” hydrocarbons may also include other types of hydrocarbons, unless otherwise specified.

In this discussion, references to a “gas portion” or a “liquid portion” of a reaction effluent refer to the phase the effluent portion would be in at 20° C. and 100 kPa-a. In this discussion, references to a “gas phase portion” or a “liquid phase portion” of a reaction effluent refer to the phase the effluent portion is in at the specified conditions. For example, a “gas phase portion” of a hydrocracking effluent as the effluent exits from the reactor would refer to the portion of the hydrocracking effluent that is in the gas phase under the conditions present at the exit from the hydrocracking reactor. This could include compounds that boil at up to 400° C. or more, depending on the temperature at the exit from the hydrocracking reactor. By contrast, the “gas portion” of such a hydrocracking effluent would only correspond to the components of the effluent that are gas phase at 20° C. and 100 kPa-a, such as C₄₋ hydrocarbons, carbon oxides, hydrogen, H₂S, and other low boiling compounds.

In this discussion, references to a periodic table are defined as references to the current version of the IUPAC Periodic Table.

### Fischer-Tropsch Wax and Other Waxy Feedstocks

In various aspects, a noble metal catalyst on an amorphous silica-alumina support can be used for hydrocracking of a waxy feedstock, such as wax produced by Fischer-Tropsch synthesis. Fischer-Tropsch synthesis is generally performed by exposing synthesis gas to an appropriate catalyst under Fischer-Tropsch synthesis conditions. Fischer-Tropsch synthesis reactions generally produce products containing a large proportion of paraffins (alkanes). Paraffins containing more than roughly 20 carbons typically correspond to compounds with boiling points above 371° C. Generally, a waxy feedstock corresponds to a feedstock with a T10 distillation point of 280° C. or higher, or 300° C. or higher, or 315° C. or higher, or 343° C. or higher, or 371° C. or higher. The T90 distillation point of a waxy feedstock and/or the final boiling point can be any convenient value, so long as the waxy feedstock has a sufficiently low viscosity to be able to be transported into the hydrocracking reactor using conventional methods. In some aspects, a waxy feedstock can have a T90 distillation point of 500° C. or more. In some aspects, a waxy feedstock can have a T90 distillation point of 650° C. or less. Such a waxy feedstock can be formed in any convenient manner. For example, after performing Fischer-Tropsch synthesis, the resulting liquid products can be separated to form one or more lower boiling fractions (such as a naphtha fraction and/or a distillate fraction and/or a light ends or gas fraction) and at least one higher boiling fraction with a T10 distillation point of 315° C. or higher, or 343° C. or higher, or 371° C. or higher.

A waxy feedstock can have a relatively high content of paraffins, as determined according to D5442. In some aspects, a waxy feedstock can have a total paraffin content of 70 wt % or more, relative to a weight of the waxy feedstock, or 80 wt % or more, or 90 wt % or more, such as up to substantially all of the waxy feedstock corresponding to paraffins. In some aspects, a waxy feedstock can have an n-paraffin content of 70 wt % or more, relative to a weight of the waxy feedstock, or 80 wt % or more, or 90 wt % or more, such as up to substantially all of the waxy feedstock corresponding to n-paraffins. It is noted that a waxy feedstock produced by Fischer-Tropsch synthesis (and/or other waxy feedstocks) may have an oxygenate content of 5.0 wt % or less, or 2.5 wt % or less, or 1.0 wt % or less, such as down to 0.1 wt %, or possibly down to having substantially no content of oxygenates. If desired, such oxygenates can be removed from a waxy feedstock by any convenient method prior to hydrocracking, such as by performing an initial hydrotreatment process on the waxy feedstock.

In some aspects, such as aspects where a substantial portion of the waxy feedstock is based on Fischer-Tropsch material, the waxy feedstock can have a relatively low content of sulfur and/or nitrogen. In such aspects, the sulfur content of the waxy feed can be 100 wppm or less, or 15 wppm or less, such as down to having substantially no sulfur content (0.1 wppm or less). Additionally or alternately, the nitrogen content of the waxy feed can be 50 wppm or less, or 15 wppm or less, such as down to having substantially no nitrogen content (0.1 wppm or less). Further additionally or alternately, the waxy feedstock can have a relatively low content of aromatics. In some aspects, the aromatics content of the waxy feed can be 10 wt % or less, or 2.5 wt % or less, such as down to having substantially no aromatics content. In this discussion, aromatics content is determined according to ASTM D5186. Based on the detection limits of ASTM D5186, any aromatics content less than 1.5 wt % corresponds to a sample that is substantially free of aromatics.

In some aspects, 50 wt % or more of a waxy feedstock can correspond to compounds formed by Fischer-Tropsch synthesis, or 60 wt % or more, or 75 wt % or more, or 90 wt % or more, such as up to substantially all of the waxy feedstock corresponding to Fischer-Tropsch synthesis products. In other aspects, 50 wt % or more of a waxy feedstock can correspond to a mineral feed or fraction, or 60 wt % or more, or 75 wt % or more, such as up to 95 wt % or possibly still higher. In such aspects, if Fischer-Tropsch products are included in the waxy feedstock, the Fischer-Tropsch material can correspond to 5.0 wt % to 50 wt % of the waxy feedstock, or 5.0 wt % to 40 wt %, or 5.0 wt % to 25 wt %, or 15 wt % to 50 wt %, or 15 wt % to 40 wt %, or 15 wt % to 25 wt %. Optionally, a portion of the waxy feedstock can correspond to bio-derived components. Optionally, a portion of the waxy feedstock can correspond to bio-derived components that are not formed by a Fischer-Tropsch synthesis process. Optionally, depending on the aspect, bio-derived components (optionally not formed by Fischer-Tropsch synthesis) can correspond to 1.0 wt % to 50 wt % of a waxy feedstock, or 1.0 wt % to 20 wt %, or 1.0 wt % to 10 wt %, or 10 wt % to 50 wt %.

### Hydrocracking Conditions and Hydrocracking Products

In various aspects, a waxy feedstock can be exposed to a hydrocracking catalyst under hydrocracking conditions to produce a hydrocracked effluent. The hydrocracking catalyst can correspond to a noble metal catalyst supported on a silica-alumina support material having a beneficial combination of surface area, pore volume, and acidity. The unexpected properties for the amorphous silica-alumina support can be achieved in part by forming the support using an extrusion process where nitric acid (as a peptizing agent) and methylcellulose (as an extrusion aid) are included with the silica-alumina during the extrusion.

In various aspects, the silica-alumina support material can have a surface area of 360 m²/g or more, or 400 m²/g or more, such as up to 500 m²/g or possibly still higher. This surface area corresponds to a BET (Brunauer-Emmett-Teller) surface area that is determined prior to addition of the catalytic metal to the support. A variety of commercially available devices can determine BET surface areas, such as a Tristar gas adsorption instrument. It is noted that even though the surface area is high, the amount of micropore surface area (as determined by BET) can be relatively low. For example, the micropore surface area can be 60 m²/g or less, or 35 m²/g or less, or 15 m²/g or less, such as down to substantially no micropore surface area (less than 1.0 m²/g). Micropore surface area corresponds to surface area in pores having a pore size of 2.0 nm or less.

Additionally or alternately, in various aspects the silica-alumina support material can have a pore volume of 0.55 ml/g to 0.9 ml/g, or 0.55 ml/g to 0.79 ml/g, or 0.60 ml/g to 0.9 ml/g, or 0.60 ml/g to 0.79 ml/g. Pore volume can be determined via BET.

Further additionally or alternately, the silica-alumina support material can have a sufficiently high acidity. The acidity can be characterized, for example, by collidine adsorption using a thermogravimetric balance instrument. The sample was dried under N₂ at 200 C for 60 min. Collidine vapor carried by a N₂ flow was introduced at 200 C for 60 min followed by a N₂ flow stripping for 60 min. In various aspects, the silica-alumina support material can have an acidity that corresponds to a collidine adsorption of 110 μmoles/g or more, or 120 μmoles/g or more, such as up to 170 μmole/g or possibly still higher.

Other methods for characterizing acidity for a support can be based on ammonia adsorption and/or desorption. For example, both temperature programmed ammonia adsorption (TPAA) and temperature programmed ammonia desorption (TPAD) can be used to characterize acidity. Ammonia is a weak base that binds with acidic sites on a support if the temperature is sufficiently low, but will desorb at higher temperatures. Thus, ammonia can be used to characterize the amount of acidic sites present in a support material on a per gram basis. In TPAD, after exposing a support to a partial pressure of ammonia for a sufficient time at a relatively low temperature to achieve equilibrium, the temperature of the sample can be increased at a specified rate while either the weight of the sample is monitored or the resulting off-gas is monitored. TPAA is the reverse process, where a sample with substantially no adsorbed ammonia is exposed to a partial pressure of ammonia while the temperature is reduced to 250° C. after drying at 500° C. in air. The weight gain of the sample can be used to determine the amount of ammonia that is adsorbed. Ideally, TPAA and TPAD should result in similar acidity values. In various aspects, a support material (or a catalyst formed by adding metal to a support material) can have an acidity measured by TPAA and/or TPAD of 0.30 meq/g to 0.70 meq/g, or 0.30 meq/g to 0.55 meq/g, or 0.40 meq/g to 0.70 meq/g.

Another potential feature of the silica-alumina can be the silica content. In some aspects, the molar ratio of silica to alumina can be 0.7 or less, or 0.5 or less, such as down to 0.2 or possibly still lower. It is noted that by definition, a zeolitic material must have a silica to alumina ratio of roughly 1.0 or higher, as zeolitic materials by definition cannot include any Al—Al bonds.

The combination of surface area, pore volume, and acidity for the silica-alumina can be achieved in part by using a methylcellulose as an extrusion aid during the extrusion of the silica-alumina, in combination with nitric acid as a peptizing agent. Without being bound by any particular theory, it is believed that the combination of using nitric acid with a methylcellulose extrusion aid during extrusion of the silica-alumina allows for formation of silica-alumina with an increased surface area while also providing increased acidity. To perform an extrusion, a silica-alumina (such as Siral 30) can be mixed with methylcellulose and nitric acid. The weight ratio of silica-alumina to methylcellulose in the extrusion mixture can be between 25 to 500, or 25 to 250, or 50 to 500, or 50 to 250, or 75 to 250, or 75 to 150. The weight ratio of methylcellulose to nitric acid in the mixture can be 0.2 to 0.8, or 0.2 to 0.7, or 0.3 to 0.8, or 0.3 to 0.7. It is noted that nitric acid can typically be added to an extrusion mixture as a water based solution. The weight ratio of methylcellulose to nitric acid is based on the actual weight of nitric acid, not the weight of the nitric acid solution. The mixture is mixed until it is an appropriate consistency for extrusion. Optionally, the methylcellulose can be introduced into the extrusion mixture prior to adding the nitric acid. The solids content of the extrusion mixture can be between 40 wt % and 55 wt %. After extrusion, the resulting extrudates can be dried for a suitable time at a lower temperature, such as a temperature of 150° C. or less. The extrudates can then be calcined at a temperature that is sufficiently high to remove the methylcellulose from the extrudate, such as a temperature 500° C. or more. The desired amount of metal for the final hydrocracking catalyst can then be added in any convenient manner, such as via an incipient wetness impregnation.

In various aspects, the amount of Group 8-10 noble metal on the support can correspond to 0.1 wt % to 3.0 wt %, relative to the total weight of the catalyst (metal plus support), or 0.1 wt % to 2.0 wt %, or 0.1 wt % to 1.0 wt %, or 0.3 wt % to 3.0 wt %, or 0.3 wt % to 2.0 wt %, or 0.3 wt % to 1.0 wt %. In some aspects, the Group 8-10 noble metal can be Pt, Pd, or a combination thereof. To form a catalyst, the noble metal can be added to the support by any convenient method, such as by incipient wetness.

Prior to hydrocracking, the waxy feedstock can optionally be exposed to a hydrotreatment catalyst under hydrotreating conditions. This can allow for removal of at least a portion of oxygen, sulfur, and/or nitrogen that may be present in the waxy feedstock. Such hydrotreatment can potentially also saturate olefins and/or aromatics present in the waxy feedstock.

In some aspects, the hydrocracking conditions can include a temperature 500° F. (260° C.) to 840° F. (449° C.), or 572° F. (300° C.) to 779° F. (415° C.), or 355° C. to 449° C., or 355° C. to 415° C., a hydrogen partial pressure of 500 psig to about 3000 psig (3.45 MPag to 20.7 MPag), liquid hourly space velocities of from 0.05 h⁻¹ to 10 h⁻¹, and hydrogen treat gas rates of from 35.6 m³/m³ to 1781 m³/m³ (200 SCF/B to 10,000 SCF/B). It is noted that hydrocracking can potentially be performed at temperatures greater than 415° C. However, as the temperature increases, thermal cracking of a feed can also occur. Additionally, “overcracking” of the feed can increasingly occur at higher temperatures, so that increasing amounts of the hydrocracking products correspond to naphtha (or lower) boiling range products, as opposed to distillate boiling range conversion products. Depending on the aspect, the reaction conditions can be selected to produce 30 wt % or more conversion of the waxy feedstock relative to 371° C., or 50 wt % or more, or 70 wt % or more, such as up to substantially complete conversion of the 371° C.+ portions of the waxy feedstock to compounds boiling below 371° C.

Exposing the waxy feedstock to the hydrocracking catalyst under hydrocracking conditions results in formation of a hydrocracked effluent. The hydrocracked effluent will typically include a gas portion (at 20° C. and 100 kPa-a) and a liquid portion. The liquid portion of the hydrocracked effluent can include a naphtha boiling range fraction, a distillate boiling range fraction, and optionally an unconverted portion corresponding to components that still have a boiling point of 371° C. or higher. In some aspects, recycle of unconverted bottom with a boiling point of 371° C. or higher can be used to provide for full conversion of the feedstock over multiple passes, even though the single-pass conversion for the feed is less than 100 wt %.

### Example 1—Preparation of Catalysts

Catalyst 1: A silica-alumina self-bound support material was prepared using Siral 30 (available from Sasol) as a source of silica-alumina. This silica alumina was extruded using nitric acid as a peptizing agent and methyl cellulose as an extrusion aid. To form the extrudate, the extrusion process included mulling 253.98 g of Siral 30 with 2 grams of methylcellulose (Methocel) extrusion aid for 10 minutes. 102.33 g 3.91% HNO₃ solution was added as a peptizing agent and the mixture was mulled for 10 minutes. 96.41 g of deionized water was added and the mixture was mulled for 10 minutes, until the mixture was the appropriate consistency for extrusion. The solids content of this mixture was between 40 and 55%. The mixture was extruded at 15 rpm with cooling water on the barrel at 20° C. into 1/16″ cylinders through a die at 200 psi (˜1400 kPa) pressure at the die plat. The resulting extrudates were dried at 250° F. (120° C.) for 12 hours. The extrudates were then calcined at 1000° F. for 6 hours under air flow before cooling.

Catalyst 2 (comparative): A silica-alumina support material was used that was a commercial extrudate with a SiO₂ content of 20%.

After forming/selecting the extrudates, a Group 8-10 noble metal (either Pt or Pd) was impregnated on the extrudates. The calcined extrudates were impregnated via incipient wetness with tetraamine complexes of platinum metal. A mixture of sufficient water to fill the entire pore volume of the material as well as platinum tetraamine nitrate or palladium tetraamine nitrate were added to the extrudate with enough concentration to achieve a metals concentration of roughly 0.6 wt %-0.7 wt % Pt or 0.6 wt % Pd. The extrudates were then dried at ambient temperature, followed by further drying for 4 hours at 250° F. (120° C.). After drying, the extrudate was calcined at 680° F. (360° C.) for 3 hours in air to produce finely dispersed metal oxides on the catalyst surface.

Characterization data for the two types of supports and/or corresponding catalysts is shown in Table 1 below. Data for the Siral 30 silica-alumina prior to extrusion is also shown. In Table 1, the characterization data for the comparative catalysts is provided for a Pd-based catalyst. Although the comparative catalyst in Table 1 contains Pd instead of Pt, it is believed that the properties in Table 1 are representative of the properties of a Pt-based catalyst having the comparative support.

TABLE 1
Physical Properties of Catalysts

| | 0.7% Pt | Siral-30 | | 0.6% Pd on | silica- |
|---|---|---|---|---|---|
| | Siral-30 | self | Siral-30 | silica- | alumina |
| | self | bound | prior to | alumina | extrudate |
| | bound | ex- | extru- | (Compar- | (Compar- |
| | extrudate | trudate | sion | ative) | ative) |
| Metal Content | 0.7 wt % | — | — | 0.6 wt % | — |
| | Pt | | | Pd | |
| Si/Al ratio | 0.3 | — | — | 0.18 | — |
| Pt dispersion | 1.77/1.16 | | — | — | — |
| (H/Pt 250° C., | | | | | |
| total/strong) | | | | | |
| BET surface | — | 428 | 340 | 312 | 319 |
| area (m²/g, pre | | | | | |
| metal | | | | | |
| impregnation) | | | | | |
| Micropore | — | 0 | 0 | 23 | 0 |
| surface area | | | | | |
| (m²/g, pre | | | | | |
| metal | | | | | |
| impregnation) | | | | | |
| Pore volume | — | 0.67 | 0.72 | 0.88 | 0.74 |
| (cc/g, pre-Pt | | | | | |
| impregnation) | | | | | |
| Acidity by | 108.1 | 126.2 | 71.3 | 97.7 | — |
| Collidine | | | | | |
| Adsorption | | | | | |
| (μmols/g) | | | | | |
| TPAA | 0.508 | 0.411 | 0.474 | 0.525 | |
| (meq/g) | | | | | |
| TPAD | 0.488 | 0.397 | 0.448 | 0.508 | |
| (meq/g) | | | | | |

As shown in Table 1, extruding the Siral 30 with nitric acid and methylcellulose resulted in a substantial increase in surface area relative to the Siral 30 prior to extrusion. The ability to increase both surface area while maintaining a pore volume below 0.90 ml/g, or below 0.79 ml/g, provides the combination of properties that allow for improved activity. Additionally, it is noted that the silica-alumina extruded with nitric acid and methylcellulose provides a higher surface area and acidity than the conventionally formed silica-alumina support used for the comparative catalyst.

### Example 2—Hydrocracking of Fischer-Tropsch Wax

The catalyst supports from Example 1 were tested for their ability to hydrocrack a Fischer-Tropsch wax feed. The targeted product is distillate-range molecules, so all yields and conversion are focused on this range of molecules. In this example, the wax fraction of the feed and products is defined as having a boiling point above 371° C., and the distillate range molecules are considered to have a boiling point in the range of 160° C.-371° C. Furthermore, yields of a given fraction after conversion indicate the total amount of molecules in that boiling range present, including both pre-existing molecules that were not converted as well as those that were cracked from higher boiling fractions, in an effort to give the full picture of the yields relevant to further downstream processing. The Fischer-Tropsch feed used for generating the examples herein included roughly 25 wt % of components boiling in the range of 160° C. to 370° C. Thus, if exposed to conditions where no conversion of wax occurs, the expected distillate yield would be near 25 wt %.

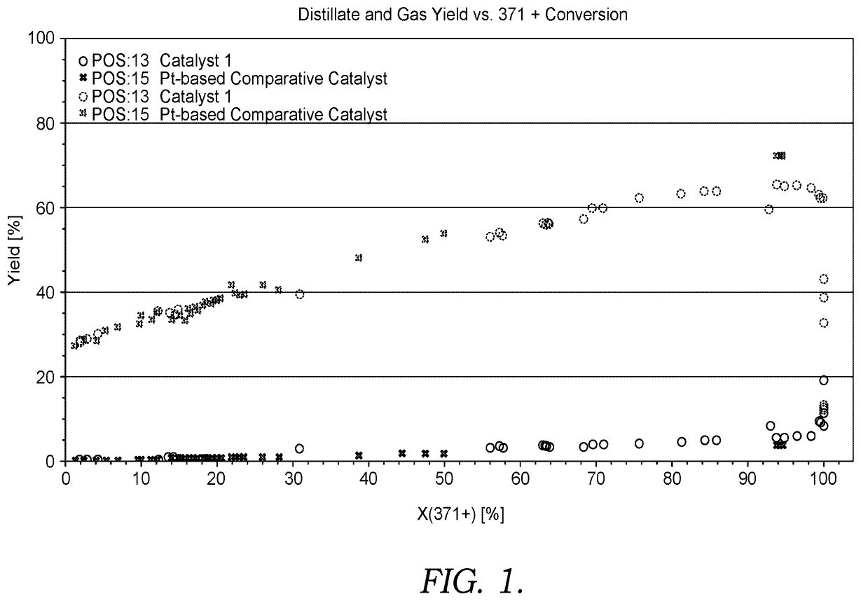

FIG. 1 shows the distillate yield versus amount of conversion for Catalyst 1 in Table 1, and for a Pt-based comparative catalyst based on the comparative support used for Catalyst 2 in Table 1. As shown in FIG. 1, Catalyst 1 and the Pt-based comparative catalyst had similar profiles for the amount of distillate yield relative to the amount of conversion, with distillate yield steadily increasing until the conversion level reached roughly 90 wt % relative to 371° C. Beyond 90 wt % conversion, the distillate yield rapidly fell due to over-cracking of the products. As indicated in Table 2 below, the yield of distillate is actually slightly higher for Catalyst 1 at a given level of conversion.

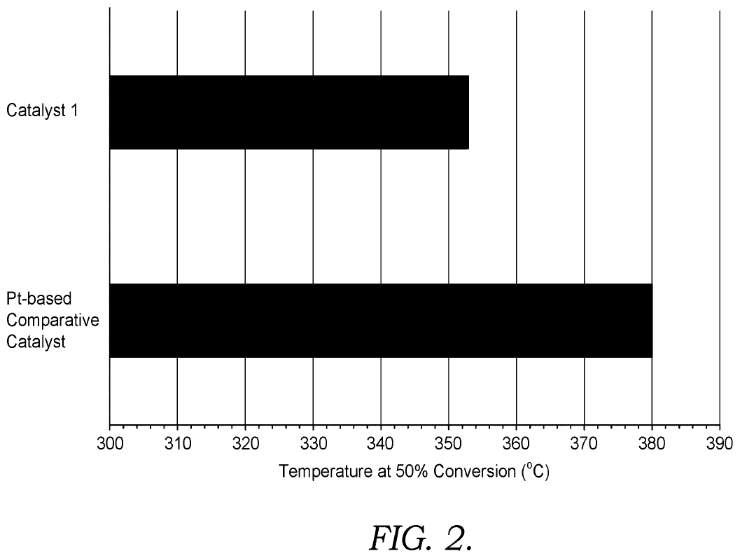

Based on FIG. 1, Catalyst 1 and the Pt-based comparative catalyst have similar profiles for producing distillate at a given level of conversion. However, the temperature required to achieve a target level of conversion for Catalyst 1 is substantially lower than the corresponding temperature that is needed for the Pt-based comparative catalyst. This is shown in FIG. 2, which shows the temperature required to achieve 50 wt % conversion of the feed relative to 371° C. As shown in FIG. 2, the temperature required for Catalyst 1 to achieve 50 wt % conversion is roughly 30° C. lower than the temperature required for the Pt-based comparative catalyst under similar conditions.

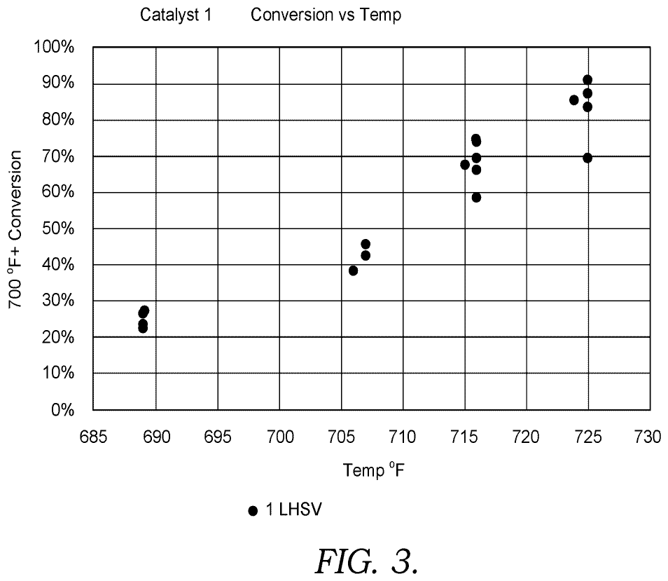

The temperature for achieving 50 wt % conversion (relative to 371° C.) is important based on run length considerations. Over time, hydrocracking catalysts tend to deactivate, resulting in less conversion at a given temperature. In order to maintain conversion at a constant value during an extended run, the temperature for the hydrocracking process is increased over time. While this is effective, it is typically desirable to avoid increasing the temperature above roughly 400° C., in order to avoid the onset of substantial thermal cracking. Thus, the lower the temperature is for a fresh catalyst to achieve 50 wt % conversion, the lower the starting hydrocracking temperature will be for that catalyst for a given feed at a target level of conversion. This means that more temperature increase is available for performing an extended run length process prior to reaching 400° C. FIG. 3 shows the amount of diesel yield relative to the hydrocracking temperature for Catalyst 1.

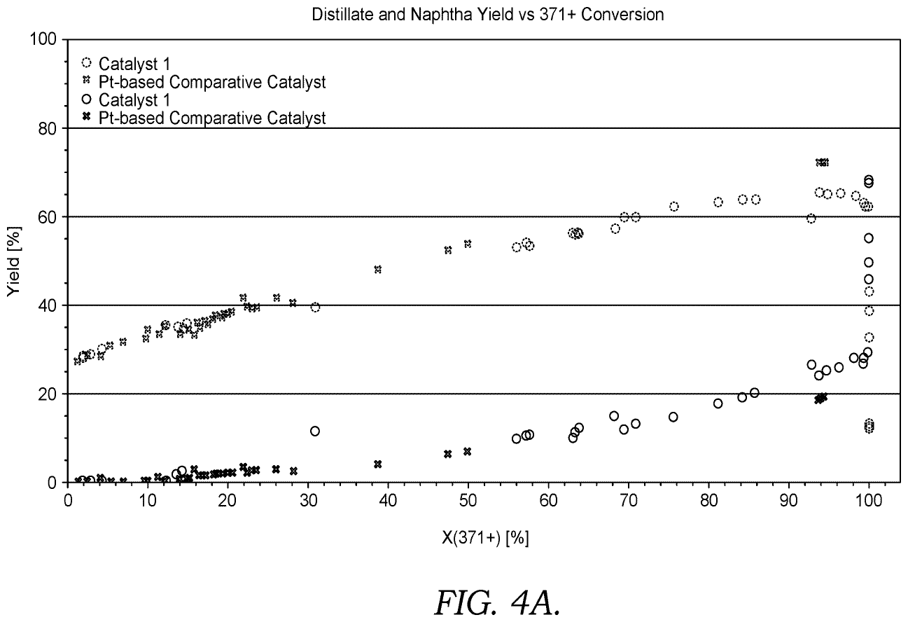

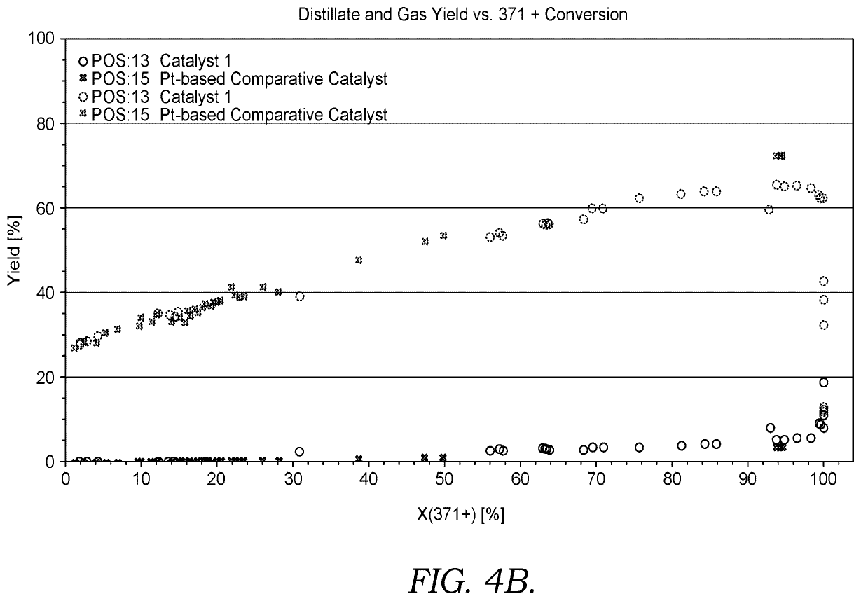

FIG. 4A and FIG. 4B provide additional details about the product yields for the two catalysts relative to the amount of feed conversion. FIG. 4A shows distillate and naphtha yield for Catalyst 1 and the Pt-based comparative catalyst, while FIG. 4B shows yields for distillate and gas phase products for the two catalysts. As shown in FIG. 4A and FIG. 4B, the yields of naphtha and gas phase products are also substantially similar for the two catalysts. This confirms that the unexpected activity benefit for the inventive catalyst is achieved while maintaining a desirable product slate.

In addition to maintaining a desirable product slate, the resulting diesel fuel generated from a catalyst as described herein also has improved properties relative to a conventional catalyst based on amorphous silica-alumina. Table 2 provides a comparison of how the product slate changes with conversion for both Catalyst 1 and comparative Catalyst 2 (the Pd-based comparative catalyst).

TABLE 2
Product Yields Versus Conversion

| | | | | | | Diesel 320- |
|---|---|---|---|---|---|---|
| | | | | | | 700° F. |
| | 700+° F. | | | | | selectivity in |
| | Conversion | C1-C5 | C6-320° F. | 320-700° F. | 700+° F. | 700−° F. |
| | % | Yield | Yield | Yield | Yield | fraction |
| Catalyst 2 | 50 | 7.4% | 11.4% | 41.6% | 39.6% | 68.87% |
| | 60 | 9.0% | 13.8% | 45.3% | 31.9% | 66.52% |
| | 70 | 10.6% | 16.3% | 49.0% | 24.0% | 64.56% |
| | 80 | 12.3% | 18.8% | 52.9% | 16.0% | 62.98% |
| Catalyst 1 | 50 | 3.6% | 8.5% | 48.8% | 39.1% | 80.13% |
| | 60 | 4.4% | 10.2% | 54.0% | 31.4% | 78.72% |
| | 70 | 5.1% | 12.0% | 59.3% | 23.6% | 77.62% |
| | 80 | 5.9% | 13.7% | 64.6% | 15.8% | 76.72% |

As shown in Table 2, Catalyst 1 provides a small but substantial yield advantage for diesel at all conversion levels between 50% and 80%, while reducing the yield of light ends. In addition to the yield improvement, the resulting diesel product generated using Catalyst 1 had improved cold flow properties. Table 3 shows characterization of diesel fractions generated using both Catalyst 1 and Catalyst 2.

TABLE 3
Characterization of Diesel Fractions

| Catalyst | Catalyst 1 | Catalyst 1 | Catalyst 2 | Catalyst 2 |
|---|---|---|---|---|
| Nominal 700+° F. | 71.1% | 82.8% | 31.0% | 42.4% |
| Conversion, wt % | | | | |
| B9364 Cloud | −22.1 | −30.4 | 8.5 | 8.6 |
| Point, ° C. | | | | |
| B3995 Total | 38.66 | 53.76 | 68.44 | 70.08 |
| Aromatics, | | | | |
| mmol/kg | | | | |
| D2887 SimDist, | | | | |
| ° F. | | | | |
| 1 wt % off | 378.6 | 328.6 | 209 | 289.9 |
| 5 wt % off | 421.4 | 396.1 | 287.8 | 353.6 |
| 20 wt % off | 479.6 | 459 | 426.9 | 457.4 |
| 50 wt % off | 563.6 | 548.5 | 564.6 | 573.4 |
| 80 wt % off | 639.8 | 632.7 | 649.1 | 651.4 |
| 95 wt % off | 686.6 | 694.2 | 716.1 | 714.8 |
| 99 wt % off | 708.6 | 722.2 | 803.8 | 782.4 |
| API GRAVITY | 48.4 | 48.9 | 50.3 | 49.3 |
| M1656 NMR | 74.26 | 71.82 | 81.43 | 82.09 |
| Cetane Number | | | | |

It is noted that the diesel fractions generated for Catalyst 2 were at comparable temperature relative to the Catalyst 1 fractions, but due to the lower activity of Catalyst 2, the resulting amount of conversion was lower. As shown in Table 3, the cloud point of the fractions formed using Catalyst 1 was substantially lower than the cloud point for the fractions generated using Catalyst 2.

### ADDITIONAL EMBODIMENTS

Embodiment 1. A method for hydrocracking a waxy feedstock, comprising: exposing a feedstock comprising 70 wt % or more of paraffins and having a T10 distillation point of 280° C. or higher to a catalyst under hydrocracking conditions comprising 20 wt % or more conversion relative to 371° C. to form a hydrocracking effluent, the catalyst comprising 0.1 wt % to 3.0 wt % of a Group 8-10 noble metal on an extruded silica-alumina support, the extruded silica-alumina support comprising a surface area of 360 m²/g or more and a pore volume of 0.55 cm³/g to 0.90 cm³/g, the hydrocracking conditions optionally comprising a temperature of 355° C. or less.

Embodiment 2. The method of Embodiment 1, wherein the extruded silica-alumina support is extruded from an extrusion mixture comprising silica-alumina, nitric acid as a peptizing agent, and methylcellulose as an extrusion aid, wherein a weight ratio of silica-alumina to methylcellulose in the extrusion mixture is between 50 and 250, or wherein a weight ratio of methylcellulose to nitric acid in the extrusion mixture is 0.2 to 0.8, or a combination thereof.

Embodiment 3. The method of any of the above embodiments, wherein the extruded silica-alumina support comprises a pore volume of 0.55 cm³/g to 0.79 cm³/g.

Embodiment 4. The method of any of the above embodiments wherein the extruded silica-alumina support comprises a surface area of 400 m²/g or more.

Embodiment 5. The method of any of the above embodiments, wherein the extruded silica-alumina support comprises a silicon to aluminum ratio of 0.2 to 0.7; or wherein the extruded silica-alumina support comprises an acidity measured by temperature programmed ammonia desorption of 0.3 meq/g to 0.7 meq/g; or wherein the extruded silica-alumina support comprises an acidity measured by collidine adsorption of 110 μmols/g or more; or a combination thereof.

Embodiment 6. The method of any of the above embodiments, wherein the extruded silica-alumina support comprises a micropore surface area of 60 m²/g or less.

Embodiment 7. The method of any of the above embodiments, wherein the feedstock comprises 70 wt % or more of n-paraffins; or wherein the feedstock comprises 50 wt % or more of Fischer-Tropsch synthesis products; or a combination thereof.

Embodiment 8. The method of any of the above embodiments wherein the feedstock comprises 1.0 wt % or more of bio-derived components.

Embodiment 9. The method of any of the above embodiments, wherein the feedstock comprises a T10 distillation point of 315° C. or more.

Embodiment 10. The method of any of the above embodiments, wherein the feedstock comprises a T10 distillation point of 343° C. or more, a T90 distillation point of 650° C. or less, or a combination thereof.

Embodiment 11. The method of any of the above embodiments, wherein the feedstock comprises a T90 distillation point of 500° C. or more.

Embodiment 12. The method of any of the above embodiments, wherein the Group 8-10 noble metal comprises Pt, Pd, or a combination thereof.

Embodiment 13. The method of any of the above embodiments, wherein the feedstock comprises 1.0 wt % or less of oxygenates.

Embodiment 14. The method of any of the above embodiments, the method further comprising hydrotreating a feed under hydrotreating conditions to form a hydrotreated effluent, the feedstock comprising a portion of the hydrotreated effluent.

Embodiment 15. The method of claim 1, wherein the feedstock comprises 80 wt % or more of paraffins; or wherein the feedstock comprises 2.5 wt % or less of aromatics; or a combination thereof.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

What is claimed is:

1. A method for hydrocracking a waxy feedstock, comprising:
exposing a feedstock comprising 70 wt % or more of paraffins and having a T10 distillation point of 280° C. or higher to a catalyst under hydrocracking conditions comprising 20 wt % or more conversion relative to 371° C. to form a hydrocracking effluent, the catalyst comprising 0.1 wt % to 3.0 wt % of a Group 8-10 noble metal on an extruded silica-alumina support, the extruded silica-alumina support comprising a surface area of 360 m²/g or more and a pore volume of 0.55 cm³/g to 0.90 cm³/g.

2. The method of claim 1, wherein the extruded silica-alumina support is extruded from an extrusion mixture comprising silica-alumina, nitric acid as a peptizing agent, and methylcellulose as an extrusion aid.

3. The method of claim 2, wherein a weight ratio of silica-alumina to methylcellulose in the extrusion mixture is between 50 and 250, or wherein a weight ratio of methylcellulose to nitric acid in the extrusion mixture is 0.2 to 0.8, or a combination thereof.

4. The method of claim 1, wherein the extruded silica-alumina support comprises a pore volume of 0.55 cm³/g to 0.79 cm³/g.

5. The method of claim 1, wherein the extruded silica-alumina support comprises a surface area of 400 m²/g or more.

6. The method of claim 1, wherein the extruded silica-alumina support comprises a silicon to aluminum ratio of 0.2 to 0.7.

7. The method of claim 1, wherein the extruded silica-alumina support comprises an acidity measured by temperature programmed ammonia desorption of 0.3 meq/g to 0.7 meq/g, or wherein the extruded silica-alumina support comprises an acidity measured by collidine adsorption of 110 μmols/g or more, or a combination thereof.

8. The method of claim 1, wherein the extruded silica-alumina support comprises a micropore surface area of 60 m²/g or less.

9. The method of claim 1, wherein the feedstock comprises 70 wt % or more of n-paraffins.

10. The method of claim 1, wherein the feedstock comprises 50 wt % or more of Fischer-Tropsch synthesis products.

11. The method of claim 1, wherein the feedstock comprises 1.0 wt % or more of bio-derived components.

12. The method of claim 1, wherein the feedstock comprises a T10 distillation point of 315° C. or more.

13. The method of claim 1, wherein the feedstock comprises a T10 distillation point of 343° C. or more, a T90 distillation point of 650° C. or less, or a combination thereof.

14. The method of claim 1, wherein the feedstock comprises a T90 distillation point of 500° C. or more.

15. The method of claim 1, wherein the Group 8-10 noble metal comprises Pt, Pd, or a combination thereof.

16. The method of claim 1, wherein the feedstock comprises 1.0 wt % or less of oxygenates.

17. The method of claim 1, the method further comprising hydrotreating a feed under hydrotreating conditions to form a hydrotreated effluent, the feedstock comprising a portion of the hydrotreated effluent.

18. The method of claim 1, wherein the feedstock comprises 80 wt % or more of paraffins.

19. The method of claim 1, wherein the feedstock comprises 2.5 wt % or less of aromatics.

20. The method of claim 1, wherein the hydrocracking conditions comprise a temperature of 355° C. or less.
